(19) United States
(12) Patent Application Publication
(10) Pub. No.: US 2013/0027766 A1
(43) Pub. Date: Jan. 31, 2013

(54) INFRARED REFLECTION FILMS

(71) Applicant: Kiyoshi ITOH, Kanagawa (JP)

(72) Inventor: Kiyoshi ITOH, Kanagawa (JP)

(21) Appl. No.: 13/192,729

(22) Filed: Jul. 28, 2011

(51) Int. Cl. G02B 5/28

(52) U.S. Cl. 359/359

(57) ABSTRACT

An infrared ray-reflecting film that includes a laminate obtained by alternately laminating two or more layers having different refractive indices on a light-transmitting substrate, in which: a difference in refractive index (e.g., for light having a wavelength of 589 nm) between any adjacent layers falls within a range of 0.1 to 0.4; and a detected peak is observed at a depth where an interfacial region between the respective layers exists in elemental analysis in a depth direction of the film by a glow discharge optical emission spectrometry. Further, a detected peak is observed at a depth where detected signals derived from components that construct adjacent layers contact each other in elemental analysis in a depth direction of the film by a glow discharge optical emission spectrometry.

### FIELD OF THE INVENTION

The present invention relates to an infrared ray-reflecting film that brings together high transmitting property for a visible light ray and high reflecting property for an infrared ray.

### BACKGROUND OF THE INVENTION

An infrared ray-reflecting film is used by being attached to a window glass of a building or a vehicle (such as an automobile, a train, a bus, an aircraft, or a ship) for the purpose of blocking an infrared ray to prevent an increase in the temperature in a room thereof, and is used for an agricultural house. The infrared ray-reflecting film can cause light to enter a room because the film transmits visible light, and one can visually identify the outside of the room from the inside of the room through the infrared ray-reflecting film. However, it is not easy to achieve compatibility between high infrared ray-reflecting property and high transparency (high transmitting property for a visible light ray). A film having high infrared ray-reflecting performance tends to have low transparency and a large weight. On the other hand, a high-transparency film tends to have low infrared ray-reflecting performance. Further, an infrared ray-reflecting film excellent in durability has been requested because the film typically continues to be exposed to sunlight over a long time period.

An infrared ray-reflecting film with its infrared ray-reflecting performance improved by laminating a large number of inorganic materials having different refractive indices on a light-transmitting substrate by a deposition method has been known as such infrared ray-reflecting film (see Patent Literature 1). However, the infrared ray-reflecting film disclosed in Patent Literature 1 requires a complicated production method and is problematic in terms of its production cost. In view of the foregoing, an infrared ray-reflecting film that achieves compatibility between high infrared ray-reflecting property and high transparency, and can be produced with good productivity at a low cost has been requested.

In view of the foregoing, an infrared ray-reflecting film produced by employing a tandem coating mode in which application and a drying treatment are repeated has been developed (see Patent Literature 2).

### CITATION LIST

### Patent Literature

[PTL 1] JP 07-237276 A
[PTL 2] JP 10-286900 A

### SUMMARY OF THE INVENTION

### Problems to be Solved by the Invention

The productivity of the infrared ray-reflecting film described in Patent Literature 2 is not necessarily high because the application and drying of its layers having various refractive indices are repeated a number of times corresponding to the number of the layers in its production process. Further, the film has been unable to sufficiently bear long-term use because the inclusion of air bubbles or impurities between the respective layers is inevitable owing to the features of its production method.

The present invention has been made under such circumstances, and an object of the present invention is to provide an infrared ray-reflecting film that achieves compatibility between high infrared ray-reflecting property and high visible light ray-transmitting property (hereinafter referred to as “transparency”), and is excellent in durability.

### Means for Solving the Problems

The inventors of the present invention have made extensive studies to solve the problems, and as a result, have found that the following infrared ray-reflecting film achieves compatibility between high infrared ray-reflecting property and high transparency, and is excellent in durability. The infrared ray-reflecting film is formed of a laminate obtained by alternately laminating two or more layers having different refractive indices on a light-transmitting substrate, a difference in refractive index for light having a wavelength of 589 nm between any adjacent layers falls within the range of 0.1 to 0.4, and a detected peak is observed at a depth where an interfacial region between the respective layers exists in elemental quantitative analysis in the depth direction of the film by a glow discharge optical emission spectrometry. The present invention has been completed on the basis of such findings.

That is, the present invention relates to the following items [1] to [10]

[1] an infrared ray-reflecting film, including a laminate obtained by alternately laminating two or more layers having different refractive indices on a light-transmitting substrate, in which:

a difference in refractive index for light having a wavelength of 589 nm between any adjacent layers falls within a range of 0.1 to 0.4; and

a detected peak is observed at a depth where an interfacial region between the respective layers exists in elemental quantitative analysis in a depth direction of the film by a glow discharge optical emission spectrometry.

[2] the infrared ray-reflecting film according to the above-mentioned item [1], in which the detected peak has a full width at half maximum of 0.01 to 3 μm.

[3] the infrared ray-reflecting film according to the above-mentioned item [1], in which the detected peak includes a peak of a carbon element.

[4] the infrared reflecting film according to the above-mentioned item [1], in which at least one layer of the laminated layers includes at least one kind selected from titanium oxide, zirconium oxide, tin oxide, indium oxide, silicon oxide, antimony oxide, tantalum pentoxide, niobium pentoxide, lanthanum oxide, yttrium oxide, zinc sulfide, ruthenium oxide, iridium oxide, zinc oxide, tin-doped indium oxide (ITO), silica (SiO₂), alumina, lanthanum fluoride, magnesium fluoride, aluminum sodium hexafluoride, Al, In, Sn, Sb, Bi, Cu, Ag, Au, Ti, Zr, Hf, V, Nb, Ta, Cr, Mo, W, Fe, Co, Ni, Pd, Pt, and alloys thereof.

[5] the infrared ray-reflecting film according to any one of the above-mentioned items [1] to [4], in which:

an odd number of layers having different refractive indices are alternately laminated;

a first layer counted from the light-transmitting substrate has a higher refractive index than a refractive index of a second layer; and

an outermost layer has a higher refractive index than a refractive index of an adjacent layer.

[6] an infrared ray-reflecting film, including a laminate obtained by alternately laminating two or more layers having different refractive indices on a light-transmitting substrate, in which:

a difference in refractive index for light having a wavelength of 589 nm between any adjacent layers falls within a range of 0.1 to 0.4; and

a detected peak is observed at a depth where detected signals derived from components that construct adjacent layers contact each other in elemental analysis in a depth direction of the film by a glow discharge optical emission spectrometry.

[7] the infrared ray-reflecting film according to the above-mentioned item [6], in which the detected peak has a full width at half maximum of 0.01 to 3 μm.

[8] the infrared ray-reflecting film according to the above-mentioned item [6], in which the detected peak includes a peak of a carbon element.

[9] the infrared reflecting film according to the above-mentioned item [6], in which at least one layer of the laminated layers includes at least one kind selected from titanium oxide, zirconium oxide, tin oxide, indium oxide, silicon oxide, antimony oxide, tantalum pentoxide, niobium pentoxide, lanthanum oxide, yttrium oxide, zinc sulfide, ruthenium oxide, iridium oxide, zinc oxide, tin-doped indium oxide (ITO), silica (SiO₂), alumina, lanthanum fluoride, magnesium fluoride, aluminum sodium hexafluoride, Al, In, Sn, Sb, Bi, Cu, Ag, Au, Ti, Zr, Hf, V, Nb, Ta, Cr, Mo, W, Fe, Co, Ni, Pd, Pt, and alloys thereof.

[10] the infrared ray-reflecting film according to any one of the above-mentioned items [6] to [9], in which:

an odd number of layers having different refractive indices are alternately laminated;

a first layer counted from the light-transmitting substrate has a higher refractive index than a refractive index of a second layer; and

an outermost layer has a higher refractive index than a refractive index of an adjacent layer.

### Effect of the Invention

The infrared ray-reflecting film of the present invention achieves compatibility between high infrared ray-reflecting property and high transparency. In addition, the film does not undergo any reduction in its interlayer adhesiveness, and can keep high infrared ray-reflecting property and high transparency even after its long-term use, in other words, is excellent in durability.

### BRIEF DESCRIPTION OF THE DRAWINGS

FIG. 1 is a schematic view illustrating an example of an apparatus for performing a simultaneous multilayer coating method.

FIG. 2 is a scanning electron microscope photograph of a section (lower layer/intermediate layer site) of an infrared ray-reflecting film obtained in Example 1.

FIG. 3 is a schematic sectional view of the infrared ray-reflecting film obtained in Example 1.

FIG. 4 is a spectrum view showing the result of the elemental quantitative analysis of an infrared ray-reflecting film obtained in Test Example 1 in its depth direction by a glow discharge optical emission spectrometry.

FIG. 5 is an example of a schematic sectional view of an infrared ray-reflecting film of the present invention.

### DESCRIPTION OF EMBODIMENTS

Infrared Ray-Reflecting Film

The infrared ray-reflecting film of the present invention is an infrared ray-reflecting film formed of a laminate obtained by alternately laminating two or more layers having different refractive indices on a light-transmitting substrate, in which: a difference in refractive index for light having a wavelength of 589 nm between any adjacent layers falls within a range of 0.1 to 0.4; and a detected peak is observed at a depth where an interfacial region between the respective layers exists in elemental quantitative analysis in a depth direction of the film by a glow discharge optical emission spectrometry.

Further, the infrared ray-reflecting film of the present invention is an infrared ray-reflecting film formed of a laminate obtained by alternately laminating two or more layers having different refractive indices on a light-transmitting substrate, in which: a difference in refractive index for light having a wavelength of 589 nm between any adjacent layers falls within a range of 0.1 to 0.4; and a detected peak is observed at a depth where detected signals derived from components that construct the respective adjacent layers contact each other in elemental quantitative analysis in a depth direction of the film by a glow discharge optical emission spectrometry.

Here, in the case of an infrared ray-reflecting film in which three or more layers are laminated, a difference in refractive index for light having a wavelength of 589 nm between adjacent layers has only to fall within the range, and differences in refractive index among all adjacent layers are not necessarily needed to be the same.

The term “interfacial region” as used herein refers to a region where the layers adjacent to each other mix with each other or to the very interface between the layers adjacent to each other when substantially no region where the layers mix with each other exists.

In addition, the glow discharge optical emission spectrometry is an approach to measuring the element distribution of the film in its depth direction, the approach involving subjecting the film or the like to serve as an analysis obj ect to high-frequency sputtering in an Ar glow discharge region and continuously dispersing the emission lines of atoms to be sputtered from the film in an Ar plasma. The method is currently the only approach that enables one to perform the elemental quantitative analysis of a multilayer film whose layer construction is unknown in its depth direction with high accuracy.

The infrared ray-reflecting film of the present invention is specifically described with reference to FIG. 5. The film has a first layer and a second layer on the light-transmitting substrate. More layers such as a third layer and a fourth layer may be further laminated on the second layer. As described in the foregoing, a difference in refractive index for light having a wavelength of 589 nm between any adjacent layers falls within the range of 0.1 to 0.4, and when the film is subjected to elemental quantitative analysis in its depth direction by the glow discharge optical emission spectrometry, a detected peak appears in the interfacial region between the respective layers (in other words, the depth at which a detected signal derived from a component that constructs the first layer and a detected signal derived from a component that constructs the second layer contact each other). A component from which the detected peak is derived exists in, for example, an interfacial region between the first layer and the second layer, and the component contributes to the maintenance of a laminated structure. Thus, the infrared ray-reflecting film is obtained.

In the elemental quantitative analysis in the depth direction by the glow discharge optical emission spectrometry, the peak top of the detected peak exists at a depth within the range of ±1.5 μm (preferably within ±1 μm, more preferably within ±0.5 μm) from the depth where the interfacial region between the respective layers exists or the depth at which detected signals derived from components that construct the respective adjacent layers contact each other. It should be noted that the detected peak refers to a peak having a full width at half maximum of preferably 0.01 to 3 μm, more preferably 0.01 to 1 μm, more preferably 0.01 to 0.6 μm, more preferably 0.05 to 0.4 μm, still more preferably 0.05 to 0.3 μm. It should be noted that the full width at half maximum represents the depth range in which a component from which the detected peak is derived spreads. As the full width at half maximum reduces, a state in which the upper and lower layers are laminated is improved. In other words, the extent to which the upper and lower layers mix with each other is reduced, and the firm is excellent as an infrared ray-reflecting film.

Detected signals derived from the components that construct the respective adjacent layers described in the foregoing are typically broad, and their detected intensities reduce at the depth where the interfacial region exists. It is because the component from which the detected peak is derived exists in the interfacial region that the detected intensities reduce at the depth where the interfacial region exists as described in the foregoing. In addition, when the detected signals derived from the components that construct the respective adjacent layers are detected signals of different elements, the detected intensity of a detected signal derived from a component that constructs the upper layer is preferably smaller than the detected intensity of a detected signal derived from a component that constructs the lower layer in the lower layer in ordinary cases, and is more preferably 30% or less, more preferably 20% or less, still more preferably 10% or less, particularly preferably 5% or less with respect to the detected intensity of the detected signal derived from the component that constructs the lower layer. It should be noted that the same holds true for the case where the upper layer and the lower layer are inverted.

Further, the detected intensity of the detected signal of the component from which the detected peak is derived is preferably smaller than the detected intensities of the detected signals derived from the components that construct the respective upper and lower layers in a region except the interfacial region, in other words, the upper and lower layers from such a viewpoint that the functions of the upper and lower layers are not inhibited, and is more preferably 50% or less, more preferably 40% or less, still more preferably 30% or less, particularly preferably 20% or less with respect to each of the detected intensities of the detected signals derived from the components that construct the respective upper and lower layers.

It should be noted that, in the specification, the elemental quantitative analysis in the depth direction by the glow discharge optical emission spectrometry was performed under the following conditions.

### (Conditions for Elemental Quantitative Analysis by Glow Discharge Optical Emission Spectrometry)

Measurement apparatus: “GDS-Profiler2” (manufactured by HORIBA, Ltd.)

RF power source output: 20 W

Argon gas pressure: 800 Pa

Anode diameter: 4 mm

Using pulse power source (frequency: 25 Hz, Duty ratio: 0.1)

Photometric mode: synchronization (pulse synchronization)

The infrared ray-reflecting film of the present invention shows a detected peak at the position described in the foregoing in the elemental quantitative analysis in its depth direction by the glow discharge optical emission spectrometry. The detected peak is preferably derived from a polymer component to be described later from the viewpoint of interlayer durable adhesiveness. In addition, the detected peak can be identified by examining an arbitrary element through the elemental quantitative analysis in the depth direction by the glow discharge optical emission spectrometry described in the foregoing. Specifically, the analysis has only to be performed by paying attention to, for example, an element (such as a carbon element) which the polymer component to be described later has.

Further, in a preferred embodiment of the infrared ray-reflecting film of the present invention, at least one layer of the laminated layers contains a polymeric mixing-preventing component at 2 to 20 mass %. In the case of the infrared ray-reflecting film in which three or more layers are laminated, such an embodiment that the polymer component is necessarily incorporated into at least one layer in any two adjacent layers is preferred from the viewpoints of infrared ray-reflecting property, transparency, and durability. In addition, from the viewpoint of infrared ray-reflecting property, it is preferred that: an odd number of layers having different refractive indices be alternately laminated; the first layer counted from the light-transmitting substrate have a higher refractive index than the refractive index of the second layer; and the outermost layer have a higher refractive index than the refractive index of the adjacent layer (in other words, the preceding layer in the inward direction). Further, the following relationship is preferably established among the laminated layers from the viewpoint of infrared ray-reflecting property. High and low refractive indices are alternately repeated, in other words, the relative refractive indices of the respective layers are arranged in a “ . . . -high-low-high-low- . . . ” order.

The difference in refractive index for light having a wavelength of 589 nm (hereinafter simply referred to as “refractive index”) between any adjacent layers, which falls within the range of 0.1 to 0.4 as described in the foregoing from the viewpoints of infrared ray-reflecting property and transparency, is preferably 0.15 to 0.4, more preferably 0.2 to 0.4. The refractive index can be adjusted by selecting a component that constructs each layer. When the difference in refractive index is less than 0.1, the infrared ray-reflecting property of the infrared ray-reflecting film becomes insufficient. On the other hand, when the difference exceeds 0.4, a moire pattern starts to be remarkable in the infrared ray-reflecting film.

It should be noted that the refractive index is a value measured in accordance with a method described in Examples.

(Components that Construct Respective Layers)

Components that construct the respective layers of the infrared ray-reflecting film of the present invention are not particularly limited as long as the difference in refractive index between any adjacent layers falls within the range of 0.1 to 0.4, and known materials to be used as components that construct the respective layers of the infrared ray-reflecting film can be used. It should be noted that a component having high transmitting property for a visible light ray is preferred and it is more desirable that such a component as described below be appropriately selected. The component has a refractive index, which is measured by the method described in Examples, of preferably 1.1 to 10.0, more preferably 1.3 to 7.0, more preferably 1.3 to 6.0, more preferably 1.3 to 3.5, still more preferably 1.3 to 3.0, particularly preferably 1.3 to 2.0. Specifically, preferred examples thereof include: inorganic oxides such as titanium oxide, zirconium oxide, tin oxide, indium oxide, silicon oxide, antimony oxide, tantalum pentoxide, niobium pentoxide, lanthanum oxide, yttrium oxide, zinc sulfide, ruthenium oxide, iridium oxide, zinc oxide, tin-doped indium oxide (ITO), silica (SiO₂), and alumina; metal fluorides such as lanthanum fluoride, magnesium fluoride, and aluminum sodium hexafluoride; metals such as Al, In, Sn, Sb, Bi, Cu, Ag, Au, Ti, Zr, Hf, V, Nb, Ta, Cr, Mo, W, Fe, Co, Ni, Pd, and Pt, and alloys thereof. Of those, from the viewpoints of the visible light ray transmittance and infrared ray-reflecting performance of the infrared ray-reflecting film of the present invention, preferred are titanium oxide, zirconium oxide, tin oxide, indium oxide, silicon oxide, and antimony oxide, and more preferred are titanium oxide, silicon oxide, and tin oxide. One kind of the components may be used alone, or two or more kinds thereof may be used in combination. Further, while the shape of the component is not particularly limited, the component has a particle diameter of preferably 0.5 to 10 μm, more preferably 1 to 5 μm from the viewpoints of infrared ray-reflecting property and transparency.

From the viewpoint of a production cost, at least one layer of the laminated layers in the infrared ray-reflecting film is preferably formed of the inorganic oxide, the metal fluoride, and the metal or the alloy thereof by a sol-gel method or a thermosetting reaction, and all the layers are more preferably formed by the sol-gel method or the thermosetting reaction. It should be noted that the sol-gel method is preferred to the thermosetting reaction from the viewpoint of simplicity. Here, the sol-gel method is such a method that a solution to serve as a raw material goes through the so-called sol state in which fine particles of the inorganic oxide or the like are liberated or float to form a gel state by hydrolysis, polycondensation, or a heat treatment.

The content of the inorganic oxide, the metal fluoride, and the metal or the alloy thereof in the components that construct each layer is preferably 20 mass % or more, more preferably 50 mass % or more, more preferably 70 mass % or more, still more preferably 90 mass % or more, particularly preferably 95 mass % or more.

### (Polymer Component)

The polymer component is preferably at least one kind selected from a polystyrene, a polystyrene sulfonic acid or a salt thereof, a polyvinyl sulfonic acid or a salt thereof, and a polyvinyl alcohol and a salt thereof. Examples of the “salt thereof” in each case include alkali metal salts such as a sodium salt and a potassium salt. The polymer component has a large improving effect on interlayer durable adhesiveness and a large suppressing effect on the mixing of upper and lower layers at the stage of the production of the laminate as compared with a low-molecular weight component.

The polymer component is preferably capable of forming a film and has a weight-average molecular weight of preferably 10,000 to 100,000, more preferably 20,000 to 70,000, still more preferably 40,000 to 60,000 from the viewpoint.

The degree of sulfonation of the polystyrene sulfonic acid or the salt thereof, or of the polyvinyl sulfonic acid or the salt thereof is not particularly limited. In addition, a saponified product may be used as the polyvinyl sulfonic acid or the salt thereof, and its degree of saponification is not particularly limited. It should be noted that limitations are imposed on the degree of sulfonation and the degree of saponification upon production of the infrared ray-reflecting film. The limitations are described later.

The polymer component is incorporated at 2 to 20 mass % into the layer that is to contain the polymer component, and is incorporated at preferably 5 to 15 mass %, more preferably 7 to 13 mass % from the viewpoints of infrared ray-reflecting property, transparency, and durability. At least part of the polymer component tends to exist in a state of forming a film near an interface with an adjacent layer, and the part appears as the detected peak in the elemental quantitative analysis in the depth direction by the glow discharge optical emission spectrometry.

### (Light-Transmitting Substrate)

The light-transmitting substrate which the infrared ray-reflecting film of the present invention has is not particularly limited as long as the substrate transmits light, in other words, a visible light ray (wavelength: 360 to 830 nm). Examples of the light-transmitting substrate include light-transmitting resin substrates including polyester-based films such as a polyethylene terephthalate film, a polybutylene terephthalate film, and a polyethylene naphthalate film; polyolefin-based films such as a polyethylene film and a polypropylene film; cellulose-based films such as cellophane, a diacetylcellulose film, a triacetylcellulose film, and an acetylcellulose butyrate film; vinyl chloride-based films such as a polyvinyl chloride film and a polyvinylidene chloride film; polyvinyl alcohol films; vinyl-based copolymer films such as a ethylene/vinyl acetate copolymer film; polystyrene films; polycarbonate films; polymethylpentene films; polysulfone films; polyether-based films such as a polyetheretherketone film, a polyethersulfone film, and a polyetherimide film; polyimide films; fluororesin films; polyamide films; acrylic resin films; norbornene-based resin films; and cycloolefin resin films. Of those, the polyethylene terephthalate film is more preferred from the viewpoints of transparency and a production cost. It should be noted that the definition of the term “light-transmitting” is as described below. The substrate transmits preferably 50% or more, more preferably 70% or more, still more preferably 80% or more, particularly preferably 90% or more of visible light.

The thickness of the light-transmitting substrate is not particularly limited, and is appropriately selected depending on circumstances. In ordinary cases, the thickness is preferably 10 to 300 μm, more preferably in the range of 30 to 200 μm, still more preferably 50 to 200 μm.

Those light-transmitting substrates may be transparent, or may be semitransparent, and may be colored, or may be colorless; an appropriate substrate has only to be selected in accordance with the applications. In addition, one surface or both surfaces of the light-transmitting substrate can be subjected to a surface treatment by, for example, an oxidation method or irregularity method as desired with a view to improving adhesiveness between a surface and a layer provided on the surface. Examples of the above-mentioned oxidation method include a corona discharge treatment, a chromic acid treatment (wet), a flame treatment, a hot air treatment, and an ozone/UV irradiation treatment. In addition, examples of the irregularity method include a sandblast method and a solvent treatment method. A method for the surface treatment is appropriately selected from those methods in accordance with the kind of the light-transmitting substrate; in general, the corona discharge treatment method is preferably employed from the viewpoints of, for example, its effect and operability.

The thickness of the infrared ray-reflecting film of the present invention excluding the thickness of the light-transmitting substrate is preferably 0.5 to 15 μm, more preferably 1 to 10 μm.

Although the infrared ray-reflecting film of the present invention has an interface between the respective layers, the mixing of the layers occurs to a slight extent, and hence the film is extremely excellent in adhesiveness. Although the mixing ratio is about several mass percent (for example, preferably about 0.5 to 10 mass %, more preferably about 1 to 3 mass %) with respect to the entire layer containing the polymer component, the film can bring together infrared ray-reflecting property, transparency, and durability by virtue of the layers slightly mixing with each other while having an interface therebetween. More specifically, a visible light ray transmittance measured by a method described in Examples is as high as 75 to 85%, in more detail, 78 to 81%, an infrared ray transmittance measured by a method described in Examples is suppressed to 50% or less, in more detail, 42 to 45%, and the adhesiveness of the infrared ray-reflecting film after high-temperature, high-humidity holding measured by a method described in Examples is maintained at substantially 100% of adhesiveness before the high-temperature, high-humidity holding.

### (Method of Producing Infrared Ray-Reflecting Film)

Such infrared ray-reflecting film of the present invention as described above can be simply produced by utilizing, for example, the following method of producing a laminate.

### —Method of Producing Laminate—

A method of producing a laminate, including the steps of laminating a plurality of solutions for forming layers and transferring the laminated solutions for forming layers onto the light-transmitting substrate, in which two kinds of solutions for forming layers contacting each other are classified into a “hydrophilic organic solvent-based solution” and an “aqueous solution,” and the polymer component that prevents the mixing of the two kinds of solutions for forming layers is included in advance into at least one solution for forming a layer so that a layer interface after the lamination may be secured.

### (Solution for Forming Layer)

Upon formation of each layer of the infrared ray-reflecting film of the present invention, a sol liquid containing a component that constructs the layer, the polymer component, and a solvent is preferably used as a solution for forming a layer.

Examples of the solvent which the sol liquid contains include water, and hydrophilic organic solvents typified by alcohol-based organic solvents such as methanol, ethanol, propanol, butanol, and 1-methoxy-2-propanol. A solution for forming a layer using water as a main solvent is referred to as “aqueous solution,” and a solution for forming a layer using a hydrophilic organic solvent as a main solvent is referred to as “hydrophilic organic solvent-based solution.” Details about those solutions are described later.

The concentration of the component that constructs each layer in the solution for forming a layer is preferably 30 to 80 mass %, more preferably 30 to 60 mass %, still more preferably 30 to 50 mass % from such a viewpoint that the sol-gel method is efficiently performed. In addition, the concentration of the polymer component in the solution for forming a layer is preferably 1 to 30 mass %, more preferably 1 to 20 mass %, more preferably 2 to 15 mass %, still more preferably 3 to 10 mass % from such a viewpoint that the sol-gel method is efficiently performed.

A commercial product is preferably used as such sol liquid because of its simplicity. Examples of the commercial product include: an “AERODISP (registered trademark)-W740” (manufactured by Nippon Aerosil Co., Ltd., water dispersion); a Suncolloid (registered trademark) series such as a “Suncolloid HX-M5” (manufactured by Nissan Chemical Industries, Ltd., alcohol dispersion); and an OPT LAKE (registered trademark) series such as an “OPT LAKE 1120Z BRU-25” (manufactured by JGC Catalysts and Chemicals Ltd., methanol dispersion).

As described in the foregoing, the method of producing a laminate includes the steps of: laminating a solution A for forming a layer (upper layer solution) and a solution B for forming a layer (lower layer solution); and transferring the laminated solutions for forming layers onto the light-transmitting substrate to produce the laminate.

A method of laminating the solution A for forming a layer for an upper layer and the solution B for forming a layer for a lower layer, which is not particularly limited, is, for example, (1) a method involving laminating the solutions on an inclined slide surface, (2) a method involving laminating the solutions on a horizontal plane, (3) a method involving laminating the solutions on a circular cylinder, or (4) a method involving laminating the solutions on an inclined paraboloid. Of those, the method (1) is preferably employed in ordinary cases.

One of the solution A for forming a layer and the solution B for forming a layer must be a hydrophilic organic solvent-based solution and the other must be an aqueous solution in order that a layer interface may be secured after the lamination of these solutions. It does not matter which one of the solution A for forming a layer for an upper layer and the solution B for forming a layer for a lower layer is a hydrophilic organic solvent-based solution.

### (Medium of Hydrophilic Organic Solvent-Based Solution)

The hydrophilic organic solvent which the hydrophilic organic solvent-based solution contains has a solubility in water of preferably 1 g/100 ml or more, more preferably 50 g/100 ml or more, and still more preferably mixes in an arbitrary amount with water from the viewpoint of the suppression of rejection between two layers to be laminated. In addition, the hydrophilic organic solvent-based solution is preferably an alcohol-based solution from the viewpoints of volatility and environmental protection. An alcohol to be used in the alcohol-based solution is preferably a hydrophilic compound having a hydroxyl group from the viewpoint of interlayer adhesiveness, and examples of the alcohol include methanol, ethanol, n-propanol, isopropanol, isobutanol, and ethylene glycol. The boiling point of the alcohol is preferably 40 to 120° C., more preferably 50 to 80° C. from the viewpoint of the shortening of a drying time to be described later. One kind of such alcohols may be used alone, or two or more kinds thereof may be used in combination.

Although an organic solvent except the alcohol, the solvent having an affinity for the alcohol, or water may be used as a medium in combination in the hydrophilic organic solvent-based solution, the content of the alcohol with respect to the total amount of the mediums is preferably 80 mass % or more (more preferably 90 mass % or more, more preferably 95 mass % or more, still more preferably substantially 100 mass %) from the viewpoint of the layer interface-securing effect of the component for preventing mixing.

### (Medium of Aqueous Solution)

Water which the aqueous solution contains is not particularly limited, and ion-exchanged water, distilled water, or the like can be used. Although a water-soluble organic solvent such as acetone, methanol, or methyl ethyl ketone may be used as a medium in the aqueous solution in combination with water, the water content with respect to the total amount of the mediums is preferably 80 mass % or more (more preferably 90 mass % or more, more preferably 95 mass % or more, still more preferably substantially 100 mass %) from the viewpoint of the layer interface-securing effect of the component for preventing mixing.

In the present invention, the following method (a) and/or the following method (b) can each/can be preferably employed as a method of including the polymer component into at least one of the two kinds of solutions for forming layers contacting each other. The method (a) involves including a polymer component having a solubility in the hydrophilic organic solvent of 50 mg/100 ml or more and a solubility in water of 1 mg/100 ml or less into the hydrophilic organic solvent-based solution. The method (b) involves including a polymer component having a solubility in water of 50 mg/100 ml or more and a solubility in the hydrophilic organic solvent of 1 mg/100 ml or less into the aqueous solution. The method (a) is preferred as the method.

It is because a polymer component that arbitrarily dissolves in the hydrophilic organic solvent or water is also included in the category of the present invention that no upper limit is provided for the solubility in the hydrophilic organic solvent or water, which is 50 mg/100 ml or more.

It should be noted that the term “polymer component having a solubility in the hydrophilic organic solvent of 50 mg/100 ml or more and a solubility in water of 1 mg/100 ml or less” refers to preferably a polymer component having a solubility in the hydrophilic organic solvent of 70 mg/100 ml or more and a solubility in water of 1 mg/100 ml or less, more preferably a polymer component having a solubility in the hydrophilic organic solvent of 80 mg/100 ml or more and a solubility in water of 1 mg/100 ml or less, still more preferably a polymer component having a solubility in the hydrophilic organic solvent of 100 mg/100 ml or more and a solubility in water of 0.5 mg/100 ml or less.

Further, the term “polymer component having a solubility in water of 50 mg/100 ml or more and a solubility in the hydrophilic organic solvent of 1 mg/100 ml or less” refers to preferably “a polymer component having a solubility in water of 70 mg/100 ml or more and a solubility in the hydrophilic organic solvent of 1 mg/100 ml or less”, more preferably “a polymer component having a solubility in water of 80 mg/100 ml or more and a solubility in the hydrophilic organic solvent of 1 mg/100 ml or less”, still more preferably “a polymer component having a solubility in water of 100 mg/100 ml or more and a solubility in the hydrophilic organic solvent of 0.5 mg/100 ml or less”.

### (Polymer Component)

Given below is more detailed description of the polymer component, which has been described in the foregoing, upon employment of the method of producing a laminate.

Examples of the polymer component having a solubility in the hydrophilic organic solvent of 50 mg/100 ml or more and a solubility in water of 1 mg/100 ml or less include a polyvinyl alcohol (PVA) having a degree of saponification of 30 to 45 mol % (preferably 30 to 40 mol %), a polystyrene sulfonic acid having a degree of sulfonation of 5 to 20 mol % and a salt thereof, and a polyvinyl sulfonic acid having a degree of sulfonation of 5 to 20 mol % and a salt thereof.

Further, examples of the polymer component having a solubility in water of 50 mg/100 ml or more and a solubility in the hydrophilic organic solvent of 1 mg/100 ml or less include a polyvinyl alcohol (PVA) having a degree of saponification of 80 to 100 mol %, a polystyrene sulfonic acid having a degree of sulfonation of 60 to 100 mol % and a salt thereof, and a polyvinyl sulfonic acid having a degree of sulfonation of 60 to 100 mol % and a salt thereof.

The aqueous solution and the hydrophilic organic solvent-based solution mix with each other in ordinary cases because both the solutions have affinities for each other. In the production method, however, an interface can be stably secured probably because of the following reason. When the above-mentioned polymer component is used, the polymer component is immediately insolubilized to precipitate upon contact of the two kinds of solutions for forming layers because of its poor solubility in one of the solutions, and hence the diffusion and mixing of both the solutions are effectively prevented or suppressed. It is probably because of the following reason that the mixing of both the solutions can be efficiently prevented or suppressed despite the fact that the embodiment is not such that an intermediate layer is interposed between the aqueous solution and the hydrophilic organic solvent-based solution. The included polymer component affects the properties of the entire solutions for forming layers, and as a result, the affinity of one of the solutions for forming layers for the other can be efficiently reduced to such an extent that the layer interface can be secured.

It should noted that the layer-separated structure of the laminate can be observed with, for example, an interfacial ultraviolet and visible spectrophotometer utilizing slab optical waveguide spectrometry. The structure can be observed by investigating its section with a scanning electron microscope (SEM) or an optical microscope as well.

### (Other Components)

Various additives such as an antioxidant, a UV absorber, a light stabilizer, a leveling agent, a defoaming agent, and a filler can each be further incorporated into each solution for forming a layer as required.

When attention is paid to, for example, the two solutions contacting each other, in other words, the upper layer solution A and the lower layer solution B, a method involving laminating the upper layer solution A and the lower layer solution B while causing a chemical reaction through the contact of the solution A with the solution B as well as the above-mentioned method of producing a laminate can also be employed. Any chemical reaction can be utilized as long as a product hardly soluble or insoluble in the solvents is produced by the chemical reaction at an interface between the two layers so that the laminated structure of the solutions contacting each other can be maintained. Specific examples of such reaction include (A) a crosslinking reaction between a crosslinkable polymer material having a hydroxyl group, a carboxyl group, or the like and a crosslinking agent such as a crosslinkable titanium compound, (B) an agglomeration reaction based on salting out using a hydrophilic polymer material having a hydroxyl group, a carboxyl group, or the like and an electrolyte, (C) a complex-forming reaction between a ligand such as phosphoric acid and an ionic substance such as calcium hydroxide, and (D) a neutralization reaction between an acid such as acetic acid and a base such as triethanolamine.

In addition to the foregoing, for example, the following methods are given: (i) a method involving using a catalyst and a compound that contacts the catalyst to cause a chemical reaction such as polymerization [chemical reaction: a polymerization reaction or the like]; (ii) a method involving incorporating a compound that causes a chemical reaction (such as a crosslinking reaction or a polymerization reaction) as a result of a temperature change into one solution, changing the temperatures of the solutions, and bringing the two solutions into contact with each other [chemical reaction: a crosslinking reaction, a polymerization reaction, or the like]; (iii) a method involving incorporating a compound that contacts a specific solvent to cause a chemical reaction into one solution and bringing the solution into contact with the other solution; and (iv) a method involving incorporating a compound that contacts a specific component for forming a layer to cause a chemical reaction into one solution and bringing the solution into contact with the other solution. A product produced by any such chemical reaction has only to be hardly soluble or insoluble in the solvents and exist at the interface between the two layers contacting each other.

As described in the foregoing, the method involving laminating the plurality of solutions for forming layers and transferring the laminated solutions for forming layers onto the light-transmitting substrate is adopted as a method of producing a laminate that can be utilized in the production of the infrared ray-reflecting film.

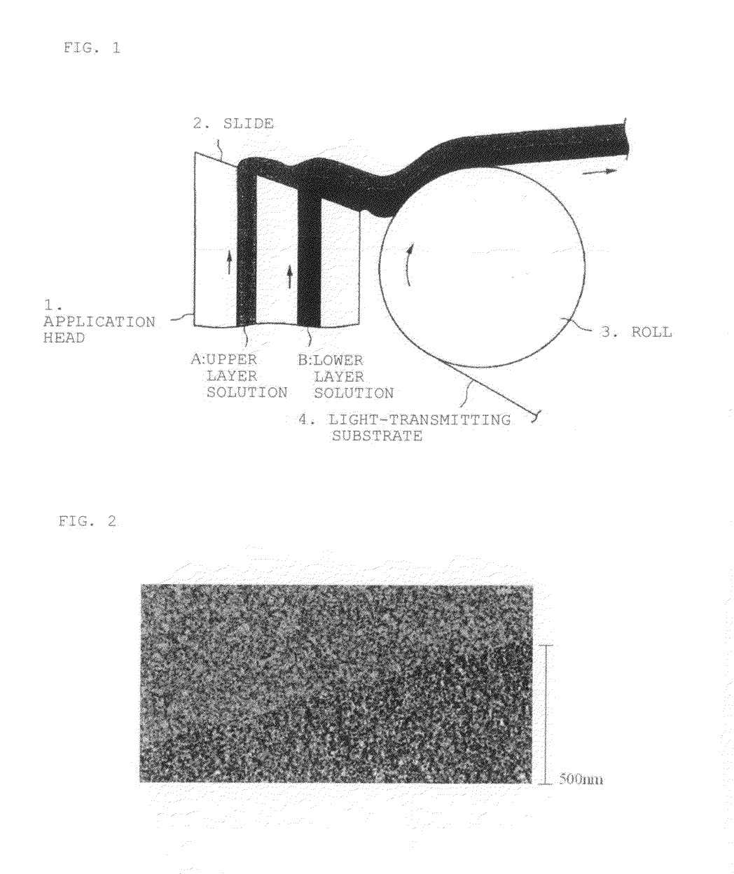

When the inclined slide surface is employed upon lamination, a product having an inclined slide surface for causing the solutions for forming layers to flow is preferably, for example, such a slide coater as illustrated in FIG. 1.

The inclination angle of the slide surface is preferably 5 to 40°, more preferably 10 to 35°, still more preferably 15 to 35° with respect to a horizontal direction from the viewpoint of efficient formation of the laminate. In addition, a distance between the center of an orifice for ejecting a solution for forming a layer onto the slide surface and the center of an adjacent orifice for ejecting a solution for forming a layer is preferably 8 to 30 cm, more preferably 10 to 28 cm, still more preferably 12 to 26 cm from the viewpoint of the efficient formation of the laminate. Further, a distance between the center of the ejection orifice closest to a site where the solutions for forming layers are transferred onto a light-transmitting substrate out of the plurality of orifices for ejecting solutions for forming layers onto the slide surface and the light-transmitting substrate is preferably 2 to 14 cm, more preferably 3 to 12 cm, still more preferably 4 to 11 cm from the viewpoint of the efficient formation of the laminate. The effect of the present invention tends to appear saliently particularly when a slide coater designed as described in the foregoing is used.

Hereinafter, an example of the method of laminating the solutions for forming layers is described in detail with reference to the slide coater of FIG. 1.

The solution A for forming a layer and the solution B for forming a layer are respectively ejected from two slit-like ejection orifices in an application head 1, and are then caused to naturally flow down on an inclined slide surface 2 by gravitation so that the solution A for forming a layer and the solution B for forming a layer may be laminated. The laminated solutions for forming layers (coating films) are transferred onto a light-transmitting substrate 4 run by a roll 3.

After having been transferred onto the light-transmitting substrate 4, the laminated solutions for forming layers (coating films) are dried under heat. Thus, the laminate can be formed. The heat drying temperature is preferably 50 to 130° C., more preferably 60 to 120° C., still more preferably 70 to 100° C. in ordinary cases. Although the heat drying time is not particularly limited, a time period of about 1 to 5 minutes is typically needed.

The infrared ray-reflecting film thus obtained is such that a difference in refractive index between any adjacent layers falls within the range of 0.1 to 0.4 and a detected peak is observed at a depth where an interfacial region between the respective layers exists in the elemental quantitative analysis in its depth direction by the glow discharge optical emission spectrometry. Alternatively, the film is such that a difference in refractive index between any adjacent layers falls within the range of 0.1 to 0.4 and a detected peak is observed at a depth where detected signals derived from components that construct the respective adjacent layers contact each other in the elemental quantitative analysis in its depth direction by the glow discharge optical emission spectrometry.

### EXAMPLES

Next, the present invention is described in more detail by way of examples. However, the present invention is by no means limited by those examples. It should be noted that the following light-transmitting substrate was used in each example. Further, the visible light ray transmittance, infrared ray transmittance, and interlayer adhesiveness of an infrared ray-reflecting film obtained in each example were measured as described below.

### (1. Light-Transmitting Substrate)

A polyethylene terephthalate film “COSMOSHINE A4100” having a thickness of 100 μm (manufactured by Toyobo Co., Ltd.) was used as a light-transmitting substrate.

### (2. Method of Measuring Visible Light Ray Transmittance)

A visible light ray transmittance was measured in conformity with JIS R3106 (1998). It should be noted that a visible light ray was applied from the side opposite to the light-transmitting substrate of an infrared ray-reflecting film.

### (3. Method of Measuring Infrared Ray Transmittance)

An infrared ray transmittance (solar transmittance) was measured in conformity with JIS R3106 (1998). It should be noted that an infrared ray was applied from the side opposite to the light-transmitting substrate of an infrared ray-reflecting film. The film is more excellent in infrared ray-reflecting performance as its infrared ray transmittance reduces.

### (4. Method of Measuring Adhesiveness)

Evaluation for interlayer adhesiveness was performed in conformity with the cross-cut test method of old JIS K5400 by the following evaluation method.

A heat-dissipating sheet obtained in each example was provided with 100 squares (each measuring 1 mm by 1 mm) of cross-cut notches. After that, a tape for an adherence test was attached to the grids. Then, the tape was peeled and the number of remaining squares was identified.

It can be said that the sheet is extremely excellent in interlayer adhesiveness when 95 or more squares out of its 100 squares remain.

### —Durability—

An infrared ray-reflecting film after having been held under an environment having a temperature of 80° C. and a humidity of 90% for 50 hours was subjected to the thermal conductivity measurement and adhesiveness evaluation described above. Then, the film was evaluated for its durability through comparison with that in the case of the infrared ray-reflecting film at an initial stage of its production.

The film is more excellent in durability as the extent to which a difference between its adhesivenesses becomes smaller.

### Production Example 1

### Aqueous Solution for High-Refractive Index Layer for Each of First and Third Layers)

An “AERODISP (registered trademark)-W740” (manufactured by Nippon Aerosil Co., Ltd., water dispersion of titanium oxide) was passed through a 5-μm mesh filter “Minisart 17594K” (manufactured by Hi-Tech-Inc.) so that foreign matter was removed. Thus, an aqueous solution for a high-refractive index layer was obtained.

It should be noted that a coating film was formed for refractive index measurement by coating the top of the light-transmitting substrate with the above-mentioned aqueous solution for a high-refractive index layer and then drying the solution in an oven at 120° C. for 3 minutes. The refractive index of the coating film was measured with a refractometer “Model DVA-36L” (light source: sodium D line, measurement wavelength: 589 nm, manufactured by Mizojiri Optical Co., Ltd.). As a result, the refractive index was 1.61.

### Production Example 2

### Alcohol-Based Solution for Low-Refractive Index Layer for Second Layer

An alcohol-based ink prepared by stirring and mixing a “Nano Tek SiO₂” (manufactured by C. I. Kasei Company, Limited, ethanol dispersion of silicon oxide) and a “Poly-NaSS PS-5” [manufactured by TOSOH ORGANIC CHEMICAL CO., LTD., component; corresponding to 10 mass % of a polystyrene sulfonic acid (having a weight-average molecular weight of 50,000 and a degree of sulfonation of 10 mol %) in terms of a solid matter ratio] was passed through a 5-μm mesh filter “Minisart 17594K” (manufactured by Hi-Tech-Inc.) so that foreign matter was removed. Thus, an alcohol-based solution for a low-refractive index layer was obtained.

It should be noted that a coating film was formed for refractive index measurement by coating the top of the light-transmitting substrate with the above-mentioned alcohol-based solution for a low-refractive index layer and then drying the solution in an oven at 120° C. for 3 minutes. The refractive index of the coating film was measured with a refractometer “Model DVA-36L” (manufactured by Mizojiri Optical Co., Ltd.). As a result, the refractive index was 1.38 (difference in refractive index with that in the case where the aqueous solution for a high-refractive index layer was used: 0.23).

### Production Example 3

### Alcohol-Based Solution for Low-Refractive Index Layer for Second Layer; for Comparative Example

A “Nano Tek SiO₂” (manufactured by C. I. Kasei Company, Limited, ethanol dispersion of silicon oxide) was passed through a 5-μm mesh aqueous filter so that foreign matter was removed. Thus, an alcohol-based solution for a low-refractive index layer was obtained.

### Production Example 4

### Aqueous Solution for High-Refractive Index Layer for Each of First and Third Layers

An aqueous ink prepared by stirring and mixing a “Nano Tek SnO₂” (manufactured by C. I. Kasei Company, Limited, water dispersion of tin oxide) and a “Joncryl 67” (manufactured by BASF, corresponding to 20% of an acrylic binder having a weight-average molecular weight of 12,500 in terms of a solid matter ratio) was passed through a 5-μm mesh filter (“Minisart” 17594K manufactured by Hi-Tech-Inc.) so that foreign matter was removed. Thus, an aqueous solution for a high-refractive index layer was obtained.

It should be noted that a coating film was formed for refractive index measurement by coating the top of the light-transmitting substrate with the above-mentioned aqueous solution for a high-refractive index layer and then drying the solution in an oven at 120° C. for 3 minutes. The refractive index of the coating film was measured with a refractometer “Model DVA-36L” (manufactured by Mizojiri Optical Co., Ltd.). As a result, the refractive index was 1.55.

### Production Example 5

### Aqueous Solution for High-Refractive Index Layer Containing Mixing-Preventing Component for Each of First and Third Layers

An aqueous ink prepared by stirring and mixing an “AERODISP (registered trademark)-W740” (manufactured by Nippon Aerosil Co., Ltd., water dispersion of titanium oxide) and a “Gohsenol GH-20” [manufactured by The Nippon Synthetic Chemical Industry Co., Ltd., component; corresponding to 10 mass % of a polyvinyl alcohol (having a weight-average molecular weight of 80,000) in terms of a solid matter ratio] was passed through a 5-μm mesh filter (“Minisart” 17594K manufactured by Hi-Tech-Inc.) so that foreign matter was removed. Thus, an aqueous solution for a high-refractive index layer was obtained.

It should be noted that a coating film was formed for refractive index measurement by coating the top of the light-transmitting substrate with the above-mentioned aqueous solution for a high-refractive index layer and then drying the solution in an oven at 120° C. for 3 minutes. The refractive index of the coating film was measured with a refractometer “Model DVA-36L” (manufactured by Mizojiri Optical Co., Ltd.). As a result, the refractive index was 1.59.

Table 1 below summarizes the compositions and the like of the aqueous solutions and the alcohol-based solutions obtained in Production Examples 1 to 5 described above.

TABLE 1

| | | | Refractive | | |
|---|---|---|---|---|---|
| | | | index-adjusting | Polymeric | Content |
| | | | component | component | in solid |
| | | | [concentration | [concentration | matter |
| | Solution | Solvent | (mass %)] | (mass %)] | (mass %) |
| Production | Aqueous | Water | [AERODISP-W740] | — | — |
| Example 1 | solution | | (titanium oxide) | | |
| | | | [40] | | |
| Production | Alcohol-based | Ethanol | [Nano Tek SiO₂] | “Poly-NaSS | 10 |
| Example 2 | solution | | (silicon oxide) | PS-5” | |
| | | | [40] | (polystyrene | |
| | | | | sulfonic acid) | |
| | | | | [4] | |
| Production | Alcohol-based | Ethanol | [Nano Tek SiO₂] | — | — |
| Example 3 | solution | | (silicon oxide) | | |
| | | | [40] | | |
| Production | Aqueous | Water | [Nano Tek SiO₂] | — | — |
| Example 4 | solution | | (tin oxide) | | |
| | | | [40] | | |
| Production | Aqueous | Water | [AERODISP-W740] | “Gohsenol | 10 |
| Example 5 | solution | | (titanium oxide) | GH-20” | |
| | | | [40] | (polyvinyl | |
| | | | | alcohol) | |
| | | | | [4] | |

### Example 1

### Production of Infrared Ray-Reflecting Film Formed of Three Layers

The aqueous solution prepared in Production Example 1, the alcohol-based solution prepared in Production Example 2, and the aqueous solution prepared in Production Example 1 were simultaneously applied onto the light-transmitting substrate (onto its corona-treated surface) with the slide coater illustrated in FIG. 1 (inclination angle of the slide surface; 25° with respect to a horizontal direction, distance between adjacent ejection orifices; 8 cm, distance between the center of the ejection orifice closest to a site where the solutions for forming layers were transferred onto the light-transmitting substrate and the light-transmitting substrate; 10 cm) so as to be laminated in the stated order. After the application, the resultant was dried in an oven at 120° C. for 3 minutes. Thus, a transparent infrared ray-reflecting film formed of three layers was produced. The thickness of each layer was about 6 μm.

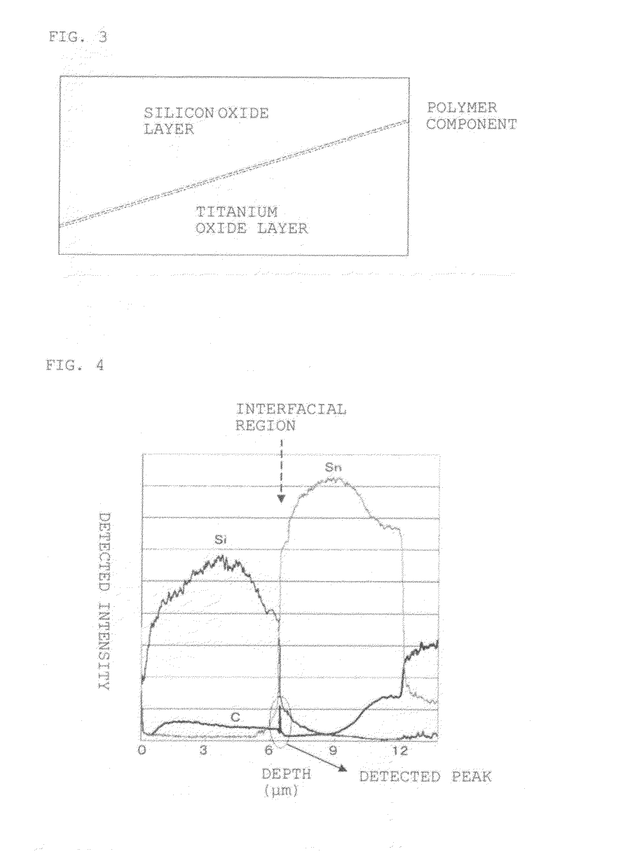

A section (lower layer/intermediate layer site) of the resultant infrared ray-reflecting film was observed with a scanning electron microscope (SEM). As a result, as shown in FIG. 2, a good laminated structure was observed. It should be noted that FIG. 3 is obtained by schematizing the section photograph of the infrared ray-reflecting film shown in FIG. 2. As can be seen from the figure, a silicon oxide layer and a titanium oxide layer are clearly separated from each other with the polymer component interposed therebetween without mixing with each other.

Table 2 shows the thicknesses of the resultant infrared ray-reflecting film, and the results of the measurement of its visible light ray transmittance, infrared ray transmittance, and adhesiveness.

### Example 2

### Production of Infrared Ray-Reflecting Film Formed of Three Layers

The aqueous coating liquid prepared in Production Example 4, the alcohol-based coating liquid prepared in Production Example 2, and the aqueous coating liquid prepared in Production Example 4 were simultaneously applied onto the light-transmitting substrate (onto its corona-treated surface) with the slide coater illustrated in FIG. 1 (inclination angle of the slide surface; 25° with respect to a horizontal direction, distance between adjacent ejection orifices; 8 cm, distance between the center of the ejection orifice closest to a site where the coating liquids were transferred onto the light-transmitting substrate and the light-transmitting substrate; 10 cm) so as to be laminated in the stated order. After the application, the resultant was dried in an oven at 120° C. for 3 minutes. Thus, a transparent infrared ray-reflecting film formed of three layers was produced. The thickness of each layer was about 6 μm.

A section of the resultant infrared ray-reflecting film was observed with a scanning electron microscope (SEM). As a result, a good laminated structure was observed.

Table 2 shows the thicknesses of the resultant infrared ray-reflecting film, and the results of the measurement of its visible light ray transmittance, infrared ray transmittance, and adhesiveness.

### Test Example 1

### Elemental Quantitative Analysis in Depth Direction of Infrared Ray-Reflecting Film by Glow Discharge Optical Emission Spectrometry

An infrared ray-reflecting film formed of two layers was produced in the same manner as in Example 2 except that only two solutions, i.e., the aqueous solution prepared in Production Example 2 and the alcohol-based solution prepared in Production Example 4 were used.

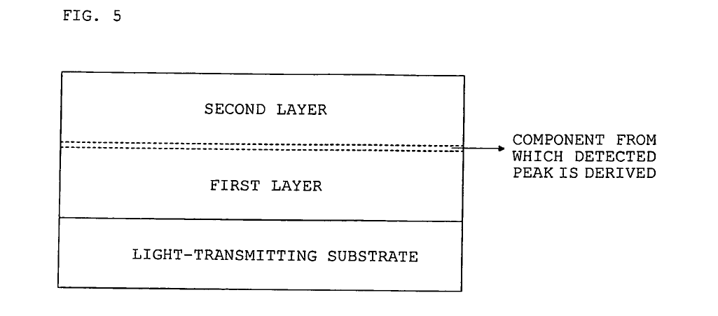

The resultant infrared ray-reflecting film was subjected to elemental quantitative analysis in the depth direction of the infrared ray-reflecting film with a glow discharge optical emission spectrometer (“GD-Profiler2” manufactured by HORIBA, Ltd.) under the following conditions. FIG. 4 shows the result. As shown in FIG. 4, the carbon element derived from the polymer component exists as a local maximum peak at the depth where the interfacial region exists or the depth at which detected signals derived from components that form the respective upper and lower layers (i.e., the peak of the silicon element and the peak of the tin element) contact each other. It should be noted that the full width at half maximum of the detected peak was 0.1 μm.

### (Conditions for Analysis by Glow Discharge Optical Emission Spectrometry)

Measurement apparatus: “GDS-Profiler2” (manufactured by HORIBA, Ltd.)

RF power source output: 20 W

Argon gas pressure: 800 Pa

Anode diameter: 4 mm

Using pulse power source (frequency: 25 Hz, Duty ratio: 0.1)

Photometric mode: synchronization (pulse synchronization) (Analyte elements and measurement wavelengths in glow discharge optical emission spectrometry)

Carbon (C): 156.144 nm

Silicon (Si): 288.158 nm

Tin (Sn): 317.505 nm

### Example 3

### Production of Infrared Ray-Reflecting Film Formed of Three Layers

The aqueous coating liquid prepared in Production Example 5, the alcohol-based coating liquid prepared in Production Example 2, and the aqueous coating liquid prepared in Production Example 5 were simultaneously applied onto the light-transmitting substrate (onto its corona-treated surface) with the slide coater illustrated in FIG. 1 (inclination angle of the slide surface; 25° with respect to a horizontal direction, distance between adjacent ejection orifices; 8 cm, distance between the center of the ejection orifice closest to a site where the coating liquids were transferred onto the light-transmitting substrate and the light-transmitting substrate; 10 cm) so as to be laminated in the stated order. After the application, the resultant was dried in an oven at 120° C. for 3 minutes. Thus, a transparent infrared ray-reflecting film formed of three layers was produced. The thickness of each layer was about 6 μm.

A section of the resultant infrared ray-reflecting film was observed with a scanning electron microscope (SEM). As a result, a good laminated structure was observed.

Table 2 shows the thicknesses of the resultant infrared ray-reflecting film, and the results of the measurement of its visible light ray transmittance, infrared ray transmittance, and adhesiveness.

### Comparative Example 1

### Production of Infrared Ray-Reflecting Film Involving Employing Tandem Coating Mode

The aqueous solution fora first layer obtained in Production Example 1 was applied to a substrate, and was then dried at 80° C. for 3 minutes. Next, the alcohol-based solution for a second layer obtained in Production Example 3 was applied to the resultant, and was then dried at 80° C. for 1 minute. Further, the aqueous solution for a third layer obtained in Production Example 1 was applied to the resultant, and was then dried at 80° C. for 1 minute. Thus, a transparent infrared ray-reflecting film formed of three layers was produced.

Table 2 shows the thicknesses of the resultant infrared ray-reflecting film, and the results of the measurement of its visible light ray transmittance, infrared ray transmittance, and adhesiveness.

TABLE 2

| | | | | Measurement result | | |
|---|---|---|---|---|---|---|
| | | | | | | Adhesiveness [initial stage |
| | | | | Infrared | Visible light | of production/after |
| | Thickness (μm) | | | ray | ray | high-temperature, |
| | First | Second | Third | transmittance | transmittance | high-humidity holding] |
| | layer | Layer | Layer | (%) | (%) | (square(s)) |
| Example 1 | 2 | 0.6 | 2 | 80.0 | 44.5 | 100/100 |
| Example 2 | 2 | 0.5 | 1.8 | 79.0 | 44.2 | 100/100 |
| Example 3 | 2 | 0.5 | 2 | 80.0 | 44.6 | 100/100 |
| Comparative | 2 | 1 | 2 | 78.9 | 42.1 | 80/35 |
| Example 1 | | | | | | |

As can be seen from Table 2, the infrared ray-reflecting film of the present invention has high transparency and high infrared ray-reflecting performance, and is excellent in adhesiveness and durability.

### INDUSTRIAL APPLICABILITY

The infrared ray-reflecting film of the present invention can be utilized for a window glass of, for example, a building or a vehicle (such as an automobile, a train, a bus, an aircraft, or a ship) and for an agricultural house.

1. An infrared ray-reflecting film, comprising a laminate obtained by alternately laminating two or more layers having different refractive indices on a light-transmitting substrate, wherein:
a difference in refractive index for light having a wavelength of 589 nm between any adjacent layers falls within a range of 0.1 to 0.4; and
a detected peak is observed at a depth where an interfacial region between the respective layers exists in elemental quantitative analysis in a depth direction of the film by a glow discharge optical emission spectrometry.

2. The infrared ray-reflecting film according to claim 1, wherein the detected peak has a full width at half maximum of 0.01 to 3 μm.

3. The infrared ray-reflecting film according to claim 1, wherein the detected peak comprises a peak of a carbon element.

4. The infrared ray-reflecting film according to claim 1, wherein at least one layer of the laminated layers comprises at least one kind selected from titanium oxide, zirconium oxide, tin oxide, indium oxide, silicon oxide, antimony oxide, tantalum pentoxide, niobium pentoxide, lanthanum oxide, yttrium oxide, zinc sulfide, ruthenium oxide, iridium oxide, zinc oxide, tin-doped indium oxide (ITO), silica (SiO₂), alumina, lanthanum fluoride, magnesium fluoride, aluminum sodium hexafluoride, Al, In, Sn, Sb, Bi, Cu, Ag, Au, Ti, Zr, Hf, V, Nb, Ta, Cr, Mo, W, Fe, Co, Ni, Pd, Pt, and alloys thereof.

5. The infrared ray-reflecting film according to claim 1, wherein:
an odd number of layers having different refractive indices are alternately laminated;
a first layer counted from the light-transmitting substrate has a higher refractive index than a refractive index of a second layer; and
an outermost layer has a higher refractive index than a refractive index of an adjacent layer.

6. An infrared ray-reflecting film, comprising a laminate obtained by alternately laminating two or more layers having different refractive indices on a light-transmitting substrate, wherein:
a difference in refractive index for light having a wavelength of 589 nm between any adjacent layers falls within a range of 0.1 to 0.4; and
a detected peak is observed at a depth where detected signals derived from components that construct adjacent layers contact each other in elemental analysis in a depth direction of the film by a glow discharge optical emission spectrometry.

7. The infrared ray-reflecting film according to claim 6, wherein the detected peak has a full width at half maximum of 0.01 to 3 μm.

8. The infrared ray-reflecting film according to claim 6, wherein the detected peak comprises a peak of a carbon element.

9. The infrared ray-reflecting film according to claim 6, wherein at least one layer of the laminated layers comprises at least one kind selected from titanium oxide, zirconium oxide, tin oxide, indium oxide, silicon oxide, antimony oxide, tantalum pentoxide, niobium pentoxide, lanthanum oxide, yttrium oxide, zinc sulfide, ruthenium oxide, iridium oxide, zinc oxide, tin-doped indium oxide (ITO), silica (SiO₂), alumina, lanthanum fluoride, magnesium fluoride, aluminum sodium hexafluoride, Al, In, Sn, Sb, Bi, Cu, Ag, Au, Ti, Zr, Hf, V, Nb, Ta, Cr, Mo, W, Fe, Co, Ni, Pd, Pt, and alloys thereof.

10. The infrared ray-reflecting film according to claim 6, wherein:
an odd number of layers having different refractive indices are alternately laminated;
a first layer counted from the light-transmitting substrate has a higher refractive index than a refractive index of a second layer; and
an outermost layer has a higher refractive index than a refractive index of an adjacent layer.
